(19) United States
(12) Patent Application Publication
(10) Pub. No.: US 2007/0055526 A1
(43) Pub. Date: Mar. 8, 2007

(54) Method, apparatus and computer program product providing prosodic-categorical enhancement to phrase-spliced text-to-speech synthesis

(75) Inventors: Ellen M. Eide, Tarrytown, NY (US); Raul Fernandez, New York, NY (US); John F. Pitrelli, Danbury, CT (US); Mahesh Viswanathan, Yorktown Heights, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 11/212,432

(22) Filed: Aug. 25, 2005

(51) Int. Cl. G10L 13/08

(52) U.S. Cl. 704/260

(57) ABSTRACT

Disclosed is a method, a system and a computer program product for text-to-speech synthesis. The computer program product comprises a computer useable medium including a computer readable program, where the computer readable program when executed on the computer causes the computer to operate in accordance with a text-to-speech synthesis function by operations that include, responsive to at least one phrase represented as recorded human speech to be employed in synthesizing speech, labeling the phrase according to a symbolic categorization of prosodic phenomena; and constructing a data structure that includes word/prosody-categories and word/prosody-category sequences for the phrase, and that further includes information pertaining to a phone sequence associated with the constituent word or word sequence for the phrase.

### TECHNICAL FIELD

These teachings relate generally to text-to-speech synthesis (TTS) methods and systems and, more specifically, relate to phrase-spliced TTS methods and systems.

### BACKGROUND

The naturalness of TTS has increased greatly with the rise of concatenative TTS techniques. Concatenative TTS first requires building a voice corpus, which entails recording a speaker reading a script, and extracting from the recordings an inventory of occurrences of speech segments such as phones or sub-phonetic units. Then, at run-time, an input text is converted to speech using a search criterion that selects the best sequence of occurrences from the inventory, and the selected best occurrences are then concatenated to form the synthetic speech. Signal processing is typically applied to smooth the region near sequence splice points at which occurrences were not adjacent in the original inventory are spliced together, thereby improving spectral continuity at the cost of sacrificing to some degree the presumably superior characteristics of the original natural speech.

The concatenative approach to TTS has been particularly fruitful when taking advantage of recent increases in computation power and memory, and improved search techniques, to employ a large corpus of several hours of speech. Large corpora offer a rich variety of occurrences, which at run-time enables the synthesizer to sequence occurrences that fit together better, such as by providing a better spectral match across splices, thereby yielding smoother and more-natural output with less processing. Large corpora also provide more complete coverage of longer passages, such as the syllables and words of the language. This reduces the frequency of splices in the output synthetic speech, instead yielding longer contiguous passages which do not require smoothing and so may retain the original natural speech characteristics.

Customizing TTS to an application domain, by including application-specific phrases in the corpus, is another means to increase opportunities to exploit natural utterances of entire words and phrases native to an application. Thus, for any given application, the best combination of the naturalness of human speech and the flexibility of concatenation can be applied to optimize output quality by using as few splices as possible given the size of the corpus and the degree to which the predictability of the material can be factored into the corpus design.

As employed herein, those systems that use large units, such as words or phrases, when available, and back off to smaller units such as phones or sub-phonetic units for those words not available in full in the corpus, maybe referred to as “phrase-splicing” TTS systems. Some systems of this variety concatenate the varying-length units, performing signal processing primarily in the vicinity of the splices. An example of a phrase-splicing TTS system is described in commonly assigned U.S. Pat. No. 6,266,637, “Phrase Splicing and Variable Substitution Using a Trainable Speech Synthesizer”, by Robert E. Donovan et al., incorporated by reference herein.

The trend toward using longer units of speech, however, has consequences. Employing few unit categories, for example about 40 phonetic categories, rather than many thousands of whole words, enables having more occurrences per category, and therefore a richer set of feature variability among those occurrences to exploit at synthesis time. Occurrences will vary in duration, fundamental frequency (f0), and other spectral characteristics owing to contextual and other inter-utterance variabilities, and state-of-the-art systems prioritize their use according to spectral-continuity criteria and conformance to predicted targets such as for f0 and duration. Using longer units, such as words and phrases, on the other hand, greatly increases the number of categories, and implies fewer occurrences per category. Hence, there is less opportunity for rich coverage of such feature variability within a category, particularly considering that the dimensionality of the space of possible features increases, for example, duration of many phones rather than just one, etc. Yet, the variety of meanings likely to be needed to be conveyed by a speech output system can be grossly overstated by the dimensionality of, for example, a vector containing f0 values for every few milliseconds of speech.

In short, state-of-the-art systems use linguistic representations, such as inventories of phones, syllables, and/or words, to categorize the corpus's occurrences of speech capable of representing a variety of texts according to meaningful distinctions. Phonetic inventories provide a parsimonious intermediate representation bridging between acoustics on one hand, and words and meaning on the other. The latter relationship is well represented by dictionaries and pronunciation rules; the former by statistical acoustic-phonetic models whose quality has improved due to a number of years of large-scale speech data collection and recognition research. Furthermore, a speaker's choice of phones for a given text is relatively constrained, e.g., words typically have a very small number of pronunciations, thereby simplifying the automatic labeling task to one of aligning a largely known sequence of symbols to the speech signal.

In contrast, categorizations of prosody are relatively immature. The search is left with nothing but low-level signal measures such as f0 and duration, whose dimensionality becomes unmanageable with the use of larger units of speech.

Standards for categorization of prosodic phenomena, such as Tones and Break Indices (ToBI), have recently emerged. However, high-accuracy automatic labeling remains elusive, impeding the use of such prosodic categorizations in existing TTS system. Furthermore, speakers can choose to impart a wide variety of prosodies to the same words, such as different word accent patterns, phrasing, breath groups, etc., thus complicating the automatic labeling process by making it one of full recognition rather than merely alignment of a nearly-known symbol sequence.

### SUMMARY OF THE PREFERRED EMBODIMENTS

The foregoing and other problems are overcome, and other advantages are realized, in accordance with the presently preferred embodiments of these teachings.

Disclosed is a method, a system and a computer program product for text-to-speech synthesis. The computer program product comprises a computer useable medium including a computer readable program. The computer readable program, when executed on the computer, causes the computer to operate in accordance with a text-to-speech synthesis function and to perform operations that include, in response to a presence of at least one phrase represented as recorded human speech to be employed in synthesizing speech, labeling the phrase according to a symbolic categorization of prosodic phenomena; and constructing a data structure that includes word/prosody-categories and word/prosody-category sequences for the phrase, and that further includes a phone sequence, or a reference to a phone sequence, that is associated with the constituent word or word sequence for the phrase.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a simplified block diagram of a concatenative text-to-speech synthesis system that is suitable for practicing this invention;

FIG. 2 is a logic flow diagram in accordance with an exemplary embodiment of a method in accordance with the invention; and

FIG. 3 is a logic flow diagram in accordance with another exemplary embodiment of a method in accordance with the invention.

### DETAILED DESCRIPTION OF THE PREFERRED EMBODIMENTS

The inventors have discovered that for those instances in which TTS is customized to a domain via phrase splicing, one may specify prosodic categories to elicit from a speaker, particularly in the case of a professional speaker who can be coached to produce the desired prosody. Then, in this case automatic labeling may not need to be required, as the tags are specified with the words during script design, and the words are aligned with the speech during a phonetic alignment process. Thus, an exemplary aspect of this invention provides a high-level categorization of prosodic phenomena, in order to represent at a symbolic level the speech signal's prosodic characteristics which are salient to meaning, and to thus improve operation of a phrase-splicing TTS system as compared to the system described in the above-referenced U.S. Pat. No. 6,266,637.

As employed herein, “prosody” may be considered to refer to all aspects of speech aside from phonemic/segmental attributes. Thus, prosody includes stress, intonation and rhythm, and “prosodic” may be considered to refer to the rhythmic aspect of language, or to the supra-segmental attributes of pitch, stress and phrasing. A “phrase” may be considered to be one word, or a plurality of words spoken in succession. In general, a “phrase” may be considered as being a speech passage of any length, or of any length greater than the basic units of concatenation used in a conventional text-to-speech synthesis systems and methods.

In accordance with an exemplary and non-limiting embodiment of the invention, speech units, or “occurrences”, are tagged according to the presence or absence of silence preceding and/or following the unit, effectively representing special prosodic effects, e.g., approaching the end of a phrase. Further in accordance with an exemplary embodiment of the invention, unit occurrences may be tagged according to the presence of punctuation on the word or words partially or completely represented by the unit, and optionally by punctuation on neighboring words. In this manner a system can explicitly distinguish, for example, that a unit is nearing the end of a question, which may imply a raised f0 at the very end but possibly also a lower f0 in preceding phones or syllables.

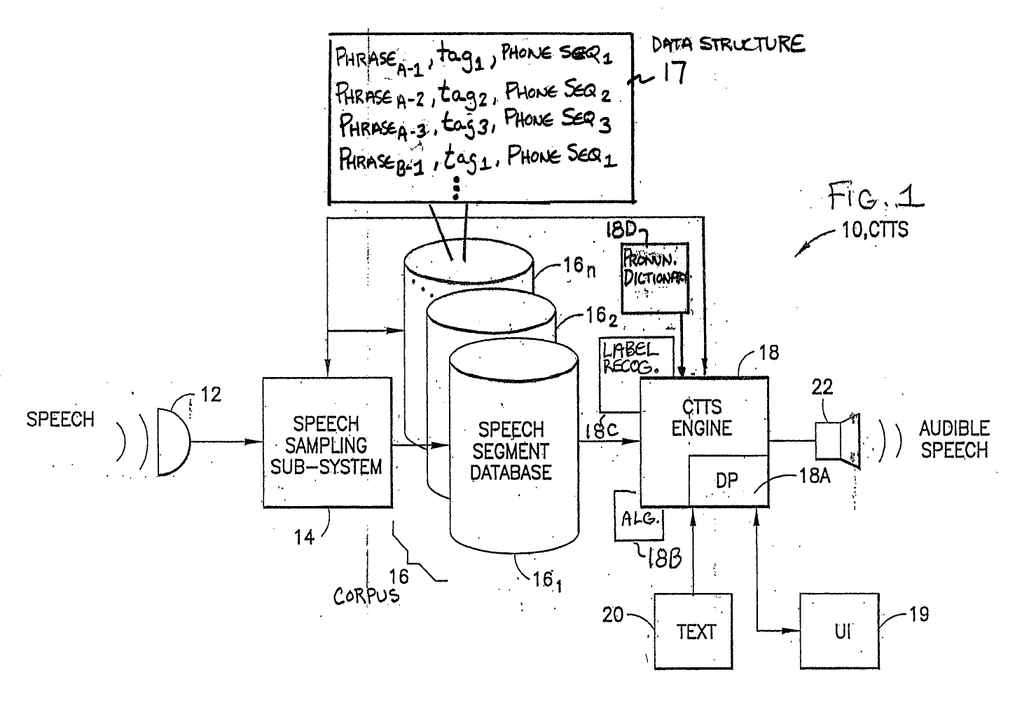

Further in accordance with an exemplary embodiment of the invention, and referring to FIG. 1, a Concatenative TTS (CTTS) system 10 employs a prosodic phonology, that is, a categorization of prosodic phenomena which provides labels for the corpus. Commonly-occurring phrases (e.g., for a particular application) may be represented in a corpus 16 by multiple occurrences of each phrase that are tagged with varying prosodic labels reflecting different meaning and syntax.

A CTTS system 10 that is suitable for practicing this invention includes a speech transducer, such as a microphone 12, having an output coupled to a speech sampling sub-system 14. The speech sampling sub-system 14 may operate at one or at a plurality of sampling rates, such as 11.025 kHz, 22.05 kHz and/or 44.1 kHz. The output of the speech sampling sub-system 14 is stored in a memory database 16 for use by a CTTS engine 18 when converting input text 20 to audible speech that is output from a loudspeaker 22 or some other suitable output speech transducer. The database, also referred to herein as the corpus 16, may contain data representing phonemes, syllables or other segments of speech. The corpus 16 also preferably contains, in accordance with the exemplary embodiments of this invention, entire phrases, for example, the above-noted commonly-occurring phrases that may be represented in the corpus 16 by multiple occurrences thereof that are each tagged with a different prosodic label to reflect different meaning and syntax.

The CTTS engine 18 is assumed to include at least one data processor (DP) 18A that operates under control of a stored program to execute the functions and methods in accordance with embodiments of this invention. The CTTS system 10 may be embodied in, as non-limiting examples, a desk top computer, a portable computer, a work station, or a main frame computer, or it may be embodied on a card or module and embedded in another system. The CTTS engine 18 may be implemented in whole or in part as an application program executed by the DP 18A. A suitable user interface (UI) 19 can be provided for enabling interaction with a user of the CTTS system 10.

The corpus 16 may be embodied as a plurality of separate databases 16₁, 16₂, . . . , 16ₙ, where in one or more of the databases are stored speech segments, such as phones or sub-phonetic units, and where in one or more of other databases are stored the prosodically-labeled phrases, as noted above. These prosodically-labeled phrases may represent sampled speech segments recorded from one or a plurality of speakers, for example two, three or more speakers.

The corpus 16 of the CTTS 10 may thus include one or more supplemental databases 16₂, . . . , 16ₙ containing the prosodically-labeled phrases, and a speech segment database 16₁ containing data representing phonemes, syllables and/or other component units of speech. In other embodiments all of this data may be stored in a single database.

American English ToBI is referred to below as a non-limiting example of a prosodic phonology which may be employed as a labeling tool. To digress, ToBI is a scheme for transcribing intonation and accent in English, and is sufficiently flexible to handle the significant intonational features of most utterances in English. Reference with regard to ToBI may be had to http://www.ling.ohio-state.edu/˜tobi/.

With regard first to metrical autosegmental phonology, ToBI assumes several simultaneous TIERS of phonological information, assumes hierarchical nesting of shorter units within longer units: word, intermediate phrase, intonational phrases, etc., and assumes one (or more) stressed syllables per major lexical word.

With regard to tones, an intonational phrase has at least one intermediate phrase, each of which has at least one Pitch Accent (but sometimes many more), each marking a specific word, and a Phrase Accent (filling in the interval between the last Pitch Accent and the end of the intermediate phrase). Each full intonational phrase ends in a Final Boundary Tone (marking the very end of the phrase). Phrase accents, final boundary tones, and their pairings occurring where an intermediate and intonational phrase end together, are sometimes collectively referred to as edge tones.

Edge tones are defined as follows:

L-, H-PHRASE ACCENT which fills the interval between the last pitch accent and the end of an intermediate phrase.

L %, H % FINAL BOUNDARY TONE occurring at every full intonation phrase boundary. This pitch effect appears only on the last one to two syllables.

% H INITIAL BOUNDARY TONE. Since the default is % L, it is not marked. % H is rare and often signals information that the listener should already know.

Thus, ignoring the % H, full intonation phrases can be seen to come in four typical types:

L-L % The default DECLARATIVE phrase;

L-H % The LIST ITEM intonation (non-final items only).

H-H % YES-NO QUESTION.

H-L % The PLATEAU. A previous H* or complex accent ‘upsteps’ the final L % to an intermediate level.

Pitch Accents mark the stressed syllable of specific words for a certain semantic effect. The star (*) marks the tone that will occur on the stressed syllable of this word. If there is a second tone, it merely occurs nearby. Intermediate phrases have one or more pitch accents. Intonational phrases have one or more intermediate phrases. An intermediate phrase ends in a phrase accent. An intonational phrase ends in a boundary tone (with a phrase accent immediately preceding it representing the end of the last intermediate phrase that it contains.

Example Pitch Accents are:

H*—PEAK ACCENT. The default accent which implies a local pitch maximum plus some degree of subsequent fall.

L*—LOW ACCENT. Also common.

L*+H—SCOOP. Low tone at beginning of target syllable with pitch rise.

L+H*—RISING PEAK. High pitch on target syllable after a sharp rise from before.

!H—DOWNSTEP HIGH. Only occurs following another H in the SAME intermediate phrase. This H is pitched somewhat lower than the earlier one, and implies that the pitch stays fairly high from the earlier H to the downstepped one. Can occur in either pitch accents, as !H*, or phrase accents, as !H-. The pattern [H*!H-L %] is known as the CALLING CONTOUR.

Definition: The NUCLEAR ACCENT is the last pitch accent that occurs in an intermediate phrase.

E.g., ‘cards’ in: “Take H* a pack of cards H*L-L %”

Break Indices are boundaries between words and occur in five levels:

0. clitic boundary, e.g.,“who's”, or “going to” when spoken as “gonna”;

1. normal word-word boundary as occurs between most phrase-medial word pairs, e.g., “see those”;

2. either perceived disjuncture with no intonation effect, or apparent intonational boundary but no slowing or other break cues;

3. intermediate phrase boundary, but not full intonational phrase boundary; marks end of word labeled with phrase accent: L- or H-;

4. full intonation phrase, a phrase- or sentence-final L % or H %.

Having thus provided an overview of ToBI, consideration is now made of an example in which American English ToBI is used as a categorization of prosodic phenomena, to be used to label the phrase “flying tomorrow” in an exemplary travel-planning TTS application. The corpus 16 may include occurrences of this phrase tagged “H*1H*1” for phrase-medial use, such as “You will be flying tomorrow at 8 P.M.”, and others tagged “H*1H*L-L % 4” for declarative phrase-final, such as “You will be flying tomorrow.” The corpus 16 may include some phrase occurrences tagged “L*1L*H-H %4” for question-final uses such as “Will you be flying tomorrow?”, and “L*1H-H %4” for others, such as this same sentence in the context of a preceding expectation of using another mode of transportation tomorrow, in which the nuclear accent should be placed on the contrasting “flying” rather than the established “tomorrow”, and so no pitch accent appears on “tomorrow”.

In a phrase-splicing or a word-splicing TTS system, the use of this invention allows a manageable multiplicity of occurrences of such larger units to be used appropriately, in conjunction with markup from the user or system driving the TTS system, specifying the prosodic categories explicitly, or an algorithm (ALG) 18B, such as a tree prediction algorithm or a set of rules, that associates syntactic and meaning categories such as those in the above example with prosodic category labels such as ToBI elements. Such an algorithm could automatically determine appropriate prosodic categories for words and phrases based on features such as position in sentence, type of sentence (question vs. declarative etc.), word frequency in discourse history, recent occurrence of contrasting words, etc. A suitable sequence of such units may then be retrieved, either using, as examples, a forced-match criterion or a cost function, thereby avoiding the need for matching at a lower level such as matching explicit f0 contours, as is done in the prior art.

The embodiments of this invention may be used in conjunction with an automatic or semi-automatic ToBI label recognizer 18C to tag the phrase-data stored in the corpus 16, and/or manual tagging of the phrase data may be employed, such as by using the user input 19, as is practical for limited numbers of words and phrases that are often used in typical applications.

In some embodiments the tags may be linked to prompts given to the speaker at the time the corpus 16 is created, thus reducing the recognition task to the task of simply verifying that the speaker produced the correct prosodic categories.

An aspect of this invention is an ability to exploit the best combination of the flexibility of subword-unit concatenative TTS with the naturalness of human speech of words and phrases known to an application and spoken with prosodies suitable to the various contexts in which those texts occur in a TTS application.

One result of the foregoing operations is that there is created a data structure 17 that includes word/prosody-categories and word/prosody-category sequences for certain phrases, and that may further include a phone sequence associated with words and word sequences for the splice phrases.

In the example shown in FIG. 1 the data structure 17 includes multiple occurrences of certain phrases, such as the phrase “flying tomorrow” as discussed above. Assume as an example that there are multiple occurrences of the phrase “flying tomorrow” (PHRASE_{A-1}, PHRASE_{A-2}, PHRASE_{A-n}), each with an associated prosodic tag (tag₁, tag₂, tagₙ) representing, for example, the phrase tagged with “H*1H*1” for phrase-medial use, another occurrence tagged “H*1H*L-L % 4” for declarative phrase-final, a third occurrence tagged “L*1L*H-H % 4” for many question-final uses, and a fourth occurrence tagged “L*1H-H % 4” for others, such as following discussion of using another mode of transportation tomorrow, in which case the nuclear accent here should be placed on the contrasting “flying”, and no pitch accent should be placed on the established “tomorrow”. While the occasions to use the first three examples may be distinguishable by the punctuation in the input text, the occasions to use the last two are more likely to be distinguished by discourse history managed by the user or system which invokes TTS, and so the distinction between these occasions of usage would typically be communicated to the synthesizer via a markup, perhaps using ToBI labels themselves.

Associated with each phrase/tag occurrence may be the data representing the corresponding phone sequence (PHONE SEQ₁, PHONE SEQ₂, PHONE SEQₙ) derived form one or more speakers who pronounced the phrase in the associated phonetic context. In an alternate embodiment there may be a pointer to the data representing the corresponding phone sequence, which may be stored elsewhere. In either case the data structure 17, and more particularly each entry therein, includes information that pertains to the unit sequence associated with a tagged phrase occurrence, such as the phonetic sequence itself or a pointer or other reference to the associated phonetic sequence. The inclusion of the prosodic-categorical information for certain phrase(s) enables more-natural-sounding speech to be synthesized based on cues in the input text, such as the presence and type of punctuation, and/or the absence of punctuation in the text. When the text is examined, a determination is made if a textual phrase appears in the data structure 17, and if it does then an appropriate occurrence of the phrase can be selected based on the associated tags, when considered with, for example, the presence and type of punctuation, and/or the absence of punctuation in the text to synthesize speech using word or multiple-word splice units. If the phrase is not found in the data structure 17, then the system may instead synthesize the word or words using, for example, one or more of phonetic, sub-phonetic and/or syllabic units.

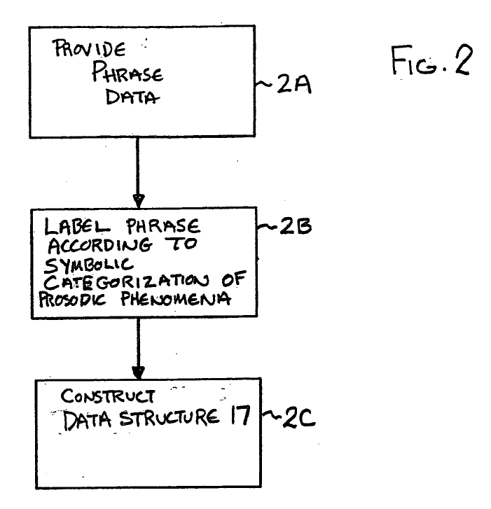

Referring to FIG. 2, a method executed by the CTTS system 10 in accordance with an exemplary embodiment of the invention includes (Block 2A) providing at least one phrase from the corpus represented as recorded human speech to be employed by combining it with synthetic speech comprised of smaller units; (Block 2B) labeling a word or words of the phrase according to a symbolic categorization of prosodic phenomena; and (Block 2C) constructing the data structure 17 that includes word/prosody-categories and word/prosody-category sequences for the splice phrase, and that may further include a phone sequence associated with words and word sequences for the splice phrase.

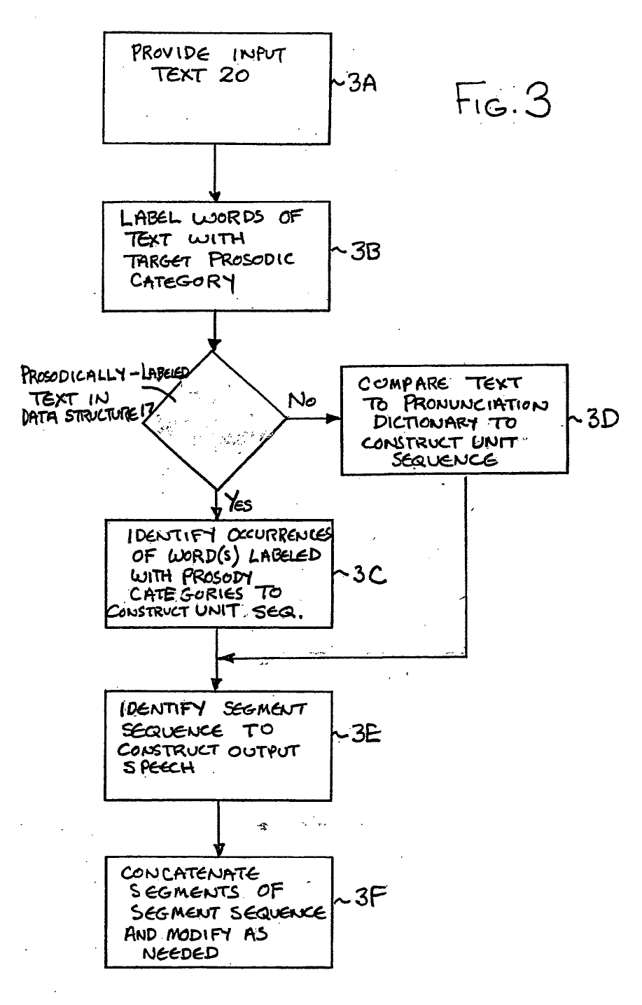

Referring to FIG. 3, a further method executed by the CTTS system 10 in accordance with an exemplary embodiment of the invention includes: (Block 3A) providing input text 20 to be converted to speech; (Block 3B) labeling words of the input text with a target prosodic category; (Block 3C) comparing the input text 20 to data in the data structure 17 to identify individual occurrences and/or sequences of words labeled with prosody categories corresponding to the input text for constructing a phone sequence; (Block 3D) alternatively comparing the input text 20 to a pronunciation dictionary 18D when the input text is not found in the data of the data structure 17; (Block 3E) identifying a segment sequence using a search algorithm to construct output speech according to the phone sequence; and (Block 3F) concatenating segments of the segment sequence, optionally modifying characteristics of the segments to be substantially equal to requested characteristics, and optionally smoothing the signal around splice points using signal processing. Note that Block 3E may use a standard concatenative TTS search algorithm with the addition of a cost function which penalizes or forbids the choice of segments whose prosodic categories do not match those specified by the targets and/or favors those which do match.

The symbolic categorization of the prosodic phenomena may consider the presence or absence of silence preceding and/or following a current word. The symbolic categorization of the prosodic phenomena may instead, or also, consider a number of words since the beginning of a current utterance, phrase or silence-delimited speech, and/or the number of words until the end of the utterance, phrase or silence-delimited speech. The symbolic categorization of prosodic phenomena may instead, or may also, consider a last punctuation mark preceding the word and/or the number of words since the punctuation mark, and/or the next punctuation mark following the word and/or the number of words until that punctuation mark. The symbolic categorization of prosodic phenomena may comprise a prosodic phonology.

The operation of comparing the input text 20 to the data in the data structure 17 to identify individual occurrences and/or sequences of words labeled with prosody categories corresponding to the input text 20 may test for an exact match of prosodic categories, and/or it may apply a cost function of various category mismatches to a search process involving at least one other matching criterion. For example, a cost matrix may be used to apply penalties, for example, a small penalty for a “close” substitution like H* for L+H*, and a larger penalty for a greater mismatch such as H* for L*.

The embodiments of this invention may be implemented by computer software executable by the data processor 18A of the CTTS engine 18, or by hardware, or by a combination of software and hardware. Further in this regard it should be noted that the various blocks of the logic flow diagrams of FIGS. 2 and 3 may represent program steps, or interconnected logic circuits, blocks and functions, or a combination of program steps and logic circuits, blocks and functions.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent speech processing techniques may be attempted by those skilled in the art. Further, the use of another type of prosodic category labeling tool (other than ToBI) may occur to those skilled in the art, when guided by these teachings. Still further, it can be appreciated that many CTTS systems will not include the microphone 12 and speech sampling sub-system 14, as once the corpus 16 (and data structure 17) is generated it can be provided in or on a computer-readable tangible medium, such as on a disk or in semiconductor memory, and need not be generated and/or updated locally.

It should be further appreciated that the exemplary embodiments of this invention allow for the possibility of hand or automatic labeling of the corpus 16, as well as for the use of hand-generated (i.e., markup) or automatically generated labels at run-time. Automatic labeling of the corpus may be accomplished using a suitably trained speech recognition system that employs techniques standard among those practiced in the art; while automatic generation of labels at run-time may be accomplished using, for example, a prediction tree that is developed using known techniques.

However, all such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. A computer program product comprising a computer useable medium including a computer readable program, wherein the computer readable program when executed on the computer causes the computer to operate in accordance with a text-to-speech synthesis function by operations comprising:
labeling a phrase according to a symbolic categorization of prosodic phenomena; and
constructing a data structure that comprises word/prosody-categories and word/prosody-category sequences for the phrase, and that further provides a phone sequence associated with the phrase.

2. The computer program product as in claim 1, where the data structure is constructed to enable a search of word/prosody categories and word/prosody-category sequences for phrases in a corpus of recordings, and which further comprises a sequence of concatenation units associated with a constituent word or word sequence for the phrase.

3. The computer program product as in claim 1, further comprising:
in response to input text to be converted to speech, labeling at least one phrase of the input text with a target prosodic category;
comparing the input text to data in the data structure to identify individual occurrences of a phrase labeled with prosody categories corresponding to the in/put text for constructing a phone sequence; and
constructing output speech according to the phone sequence.

4. The computer program product as in claim 3, where if comparing the input text to data in the data structure does not identify an occurrence of a phrase, the operations comprise instead comparing the input text to a pronunciation dictionary.

5. The computer program product as in claim 1, where the symbolic categorization of the prosodic phenomena comprises considering a presence or absence of silence that at least one of proceeds or follows a current word.

6. The computer program product as in claim 1, where the symbolic categorization of the prosodic phenomena comprises considering a number of words since at least one of a beginning of a current utterance, phrase or silence-delimited speech, or a number of words until the end of the utterance, phrase or silence-delimited speech.

7. The computer program product as in claim 1, where the symbolic categorization of the prosodic phenomena comprises considering at least one of a last punctuation mark preceding at least one of the word and/or the number of words since the punctuation mark, or a next punctuation mark following at least one of the word and/or the number of words until that punctuation mark.

8. The computer program product as in claim 1, where the symbolic categorization of the prosodic phenomena comprises a prosodic phonology.

9. The computer program product as in claim 3, where the operation of comparing the input text to the data in the data structure comprises testing for an exact match of prosodic categories.

10. The computer program product as in claim 3, where the operation of comparing the input text to the data in the data structure comprises applying a cost function of various category mismatches to a search process involving at least one other matching criterion.

11. The computer program product as in claim 1, where labeling a constituent word or word sequence of a phrase according to a symbolic categorization of prosodic phenomena comprises using a Tones and Break Indices (ToBI) analysis.

12. A text-to-speech synthesis system comprising:
means, responsive to at least one phrase represented as recorded human speech to be employed in synthesizing speech, for labeling a constituent word or word sequence of the phrase according to a symbolic categorization of prosodic phenomena; and
means for constructing a data structure comprising word/prosody-categories and word/prosody-category sequences for the phrase, and that further comprises information pertaining to a phone sequence associated with the constituent word or word sequence for the phrase.

13. The system as in claim 12, further comprising:
means, responsive to input text to be converted to speech, for labeling words of the input text with a target prosodic category;
means for comparing the input text to data in the data structure to identify individual occurrences of a word or word sequence labeled with prosody categories corresponding to the input text for constructing a phone sequence; and
means for constructing output speech according to the phone sequence.

14. The system as in claim 13, where if said means for comparing the input text to data in the data structure does not identify individual occurrences of a word or word sequence, comparing instead the input text to a pronunciation dictionary.

15. The system as in claim 12, where the symbolic categorization of the prosodic phenomena comprises considering at least one of a presence or absence of silence that at least one of proceeds or follows a current word; a number of words since at least one of a beginning of a current utterance, phrase or silence-delimited speech, or a number of words until the end of the utterance, phrase or silence-delimited speech; at least one of a last punctuation mark preceding at least one of the word or the number of words since the punctuation mark, or a next punctuation mark following at least one of the word or the number of words until that punctuation mark.

16. The system as in claim 12, where the symbolic categorization of the prosodic phenomena comprises a prosodic phonology.

17. The system as in claim 13, where said comparing means operates to at least one of test for an exact match of prosodic categories, and apply a cost function of various category mismatches to a search process involving at least one other matching criterion.

18. The system as in claim 12, where said labeling means uses a Tones and Break Indices (ToBI) analysis.

19. A method to operate a text-to-speech synthesis system, comprising:
responsive to at least one phrase represented as recorded human speech to be employed in synthesizing speech, labeling the phrase in accordance with a symbolic categorization of prosodic phenomena;
constructing a data structure that comprises word/prosody-categories and word/prosody-category sequences for the phrase, and that further includes information pertaining to a phone sequence associated with the constituent word or word sequence for the phrase;
responsive to input text to be converted to speech, labeling phrases of the input text with a target prosodic category;
comparing the input text to data in the data structure to identify an occurrences of a phrase labeled with prosody categories corresponding to the input text for constructing a phone sequence; and
constructing output speech according to the phone sequence,
where if comparing the input text to data in the data structure does not identify an occurrence of a phrase, obtaining instead a phonetic or sub-phonetic representation.

20. The method as in claim 19, where the symbolic categorization of the prosodic phenomena comprises considering at least one of a presence or absence of silence that at least one of proceeds or follows a current word; a number of words since at least one of a beginning of a current utterance, phrase or silence-delimited speech, or a number of words until the end of the utterance, phrase or silence-delimited speech; at least one of a last punctuation mark preceding at least one of the word or the number of words since the punctuation mark, or a next punctuation mark following at least one of the word or the number of words until that punctuation mark, and where the symbolic categorization of the prosodic phenomena comprises a prosodic phonology, where comparing means operates to at least one of test for an exact match of prosodic categories and apply a cost function of various category mismatches to a search process involving at least one other matching criterion, and where labeling comprises using a Tones and Break Indices (ToBI) analysis, further comprising allowing for at least one of hand or automatic labeling of a corpus, as well as for the use of one of hand-generated or automatically generated labels at run-time.
